(19) United States
(12) Patent Application Publication
(10) Pub. No.: US 2010/0023852 A1
(43) Pub. Date: Jan. 28, 2010

(54) DECLARATIVE FORMS AND VIEWS

(75) Inventors: Eray Chou, Seattle, WA (US); Jonathan Thomas Campbell, Kenmore, WA (US); Zhenguang Chen, Sammamish, WA (US); Richard Eric Andeen, Kirkland, WA (US); Gregory Chan, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/179,571

(22) Filed: Jul. 24, 2008

(51) Int. Cl. G06F 17/21

(52) U.S. Cl. 715/234

(57) ABSTRACT

Technologies are described herein for declaratively defining forms and views and for rendering the declaratively defined forms and views. A declarative and rendering technology agnostic form definition is defined and stored that defines a layout for a form. A transformation definition file is also stored that defines a transformation from the declarative form definition to renderer-specific code. A transformation is performed using the transformation definition file, the declarative form definition, and form data provided by an application to generate renderer-specific markup for the form. The desired form will be displayed when a rendering client is utilized to render the renderer-specific markup. A view may also be declaratively defined, transformed, and rendered similarly.

### BACKGROUND

Much of a user's interaction with business software application programs takes place through the use of forms and views. A form is a user interface for submitting data to an application. A form may also include the display of data provided by the application. A view is a user interface for viewing data provided by an application. A view may also be utilized to print or otherwise make use of data provided by the application.

Forms and views within a business software application program are typically specified procedurally. As a result, the creation and maintenance of business software application programs typically requires a significant amount of custom program code and expertise within a specific technology stack. This increases the complexity and cost in creating and maintaining such a business software application program.

Some business software applications utilize declarative formats to specify forms and views. These declarative formats have, however, been previously tied to a specific technology for rendering the form or view. Consequently, the creation and maintenance of such forms and views requires expertise of the particular rendering technology. Moreover, because these forms and views are defined with respect to a particular rendering technology, it can be very difficult and time consuming to convert the forms and views for use with a rendering technology other than the rendering technology for which they were originally defined.

It is with respect to these considerations and others that the disclosure made herein is presented.

### SUMMARY

Technologies are described herein for declaratively defining forms and views and for rendering the declaratively defined forms and views. According to embodiments, the forms and views are declaratively defined in a rendering technology agnostic manner. This allows the forms and views to be easily translated to and from various renderer-specific technologies. The separation of the definition of the forms and views from the technology used to render the forms and views also eases the maintenance and upgrade of an application program that uses the forms and views because much of the application is in the declarative format, as opposed to an imperative format.

According to one aspect presented herein, a declarative form definition is stored that defines a layout for a form. The declarative form definition is stored in a manner that is not dependent upon a particular technology for rendering the form (“rendering technology agnostic”). In one implementation, Extensible Markup Language (“XML”) is utilized to define the form in a declarative manner. For instance, Form Extensible Markup Language (“FormXML”) may be utilized to declaratively define a form in a rendering technology agnostic fashion.

A transformation definition file is also created and stored that defines a transformation from the declarative form definition to renderer-specific code. For instance, an Extensible Stylesheet Language Transformation (“XSLT”) may be defined for transforming the declarative form definition to renderer-specific markup, such as HyperText Markup Language (“HTML”) or Extensible Application Markup Language (“XAML”). The XSLT is schema agnostic, meaning that the same XSLT can be utilized to render views and forms specified by the declarative form definition regardless of the schema of the returned data set. Using a single XSLT file also helps scalability and can insulate forms and views from schema changes.

According to other aspects, a transformation is performed using the transformation definition file, the declarative form definition, and form data provided by an application to generate renderer-specific markup for the form. The desired form will be displayed when a rendering client, like a World Wide Web (“Web”) browser application program, is utilized to render the renderer-specific markup.

According to another aspect, a declarative view definition may be stored that declaratively defines a layout for a view. The declarative view definition is also rendering technology agnostic. For instance, View Extensible Markup Language (“ViewXML”) is utilized in one embodiment for the declarative view definition. A transformation definition file is also defined and stored that defines a transformation from the declarative view definition to renderer-specific code. A transformation may be performed using the transformation definition file, the declarative view definition, and view data received from an application to generate renderer-specific markup for the view. The view is generated when a rendering client renders the renderer-specific markup.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIG. 2 is a software architecture diagram showing aspects of one embodiment provided herein for rendering a declaratively defined form;

FIG. 3 is a flow diagram showing one process provided herein for rendering a declaratively defined form;

FIG. 4 is a schema diagram showings aspects of a FormXML schema utilized in one embodiment provided herein;

FIG. 5 is a data structure diagram showing aspects of a schema agnostic XSLT provided in one embodiment disclosed herein;

FIG. 6 is a software architecture diagram showing aspects of one embodiment provided herein for rendering a declaratively defined view;

FIG. 7 is a flow diagram showing one process provided herein for rendering a declaratively defined view; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for declaratively defining forms and views and for rendering the declaratively defined forms and views. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for declarative forms and views will be described.

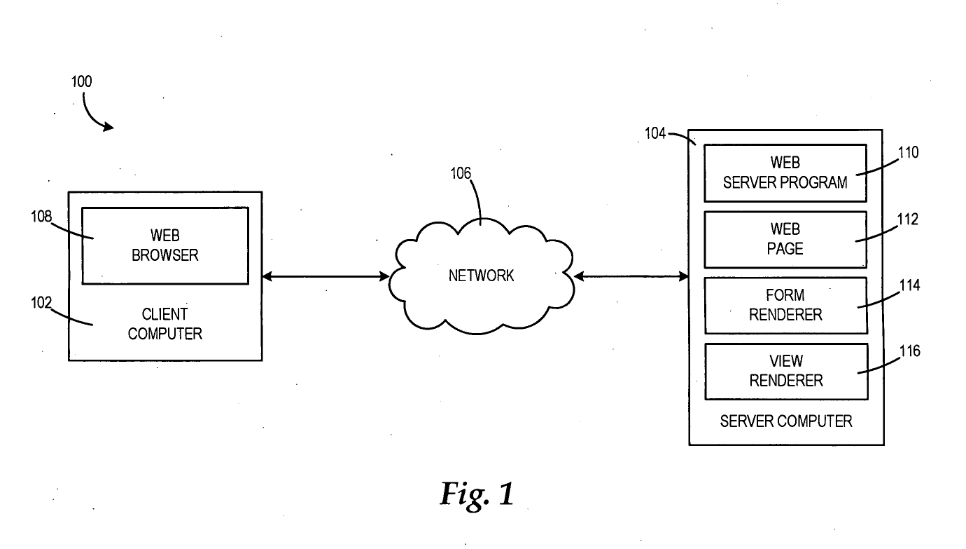

Turning now to FIG. 1, details will be provided regarding an illustrative operating environment and several software components provided by the embodiments presented herein. In particular, FIG. 1 shows aspects of a system 100 for rendering declaratively defined forms and views. The system 100 includes a client computer 102 and a server computer 104 that are interconnected through one or more local and wide area networks, such as the network 106. It should be appreciated that many more network connections may be utilized than illustrated in FIG. 1. It should also be appreciated that although one embodiment has been described herein that utilizes a client-server configuration, other configurations may also be utilized. For instance, the concepts and technologies presented herein may be utilized with a standalone client computer, a standalone server computer, handheld computing devices, set-top boxes, and virtually any other type of computing device capable of executing the software components presented herein.

The client computer 102 illustrated in FIG. 1 comprises a standard desktop or laptop computer system capable of executing an operating system and one or more application programs. In particular, according to embodiments, the client computer 102 is operative to execute a rendering client application program, such as the Web browser 108. A rendering client is an application that is capable of rendering a form or a view from markup or other types of program code. For instance, in one embodiment presented herein, the Web browser 108 is utilized to render a form or view that has been generated by the server computer 104 using HTML. It should be appreciated that the Web browser 108 is merely illustrative and that other types of rendering client application programs may be utilized to render the forms and views generated by the server computer 104 in the manner described below.

The server computer 104 shown in FIG. 1 is a standard server computer system capable of providing a Web application. For instance, in one embodiment the server computer 104 is configured to provide a business software application via a Web interface. Forms and views for interacting with the business software application are generated by the server computer 104 and provided to the Web browser 108 for rendering in the manner described below. As discussed briefly above, a form is a user interface for submitting data to an application. A form may also include the display of data provided by the application. A view is a user interface for viewing data provided by an application. A view may also be utilized to print or otherwise utilize data provided by the application. It should be appreciated that although the embodiments presented herein are discussed in the context of a business software application, the concepts and technologies presented herein may be utilized to provide forms and views for any type of computer program.

In order to provide the Web application described herein, the server computer 104 is configured to execute a Web server program 110. In one implementation, the Web server program 110 comprises the INTERNET INFORMATION SERVICES Web server program from MICROSOFT CORPORATION, of Redmond, Wash. It should be appreciated, however, that other Web server programs from other vendors might be utilized.

As known in the art, the Web server program 110 is configured to receive and respond to requests for the Web pages 112 and other resources that make up the Web application. In this regard, a Web page 112 may correspond to a form for submitting data to the Web application or to a view for viewing data provided by the Web application. When a request is received for a Web page 112 that references a form, the server computer 104 executes a form renderer 114 to generate the requested form. When a request is received for a Web page 112 that references a view, the server computer 104 executes a view renderer 116 for generating the requested view. The generated form or view is then returned to the client computer 102 for rendering and display by the Web browser 108.

Additional details regarding the execution of the form renderer 114 and the view renderer 116 will be provided below with respect to FIGS. 1-8. It should be appreciated that although the form renderer 114 and the view renderer 116 have been illustrated in FIG. 1 as separate components, their functionality may be integrated into a single component in other implementations. Other implementations may utilize more than two components.

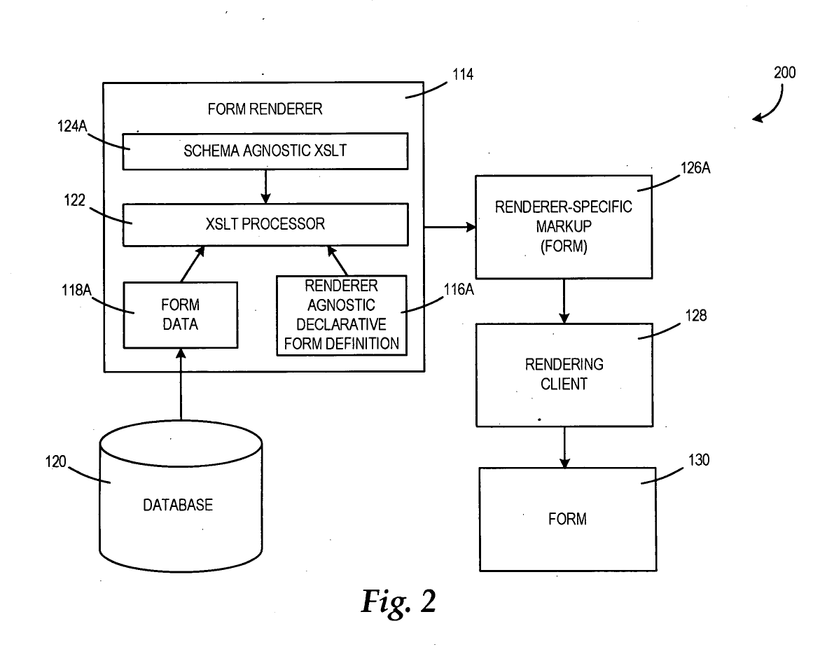

Turning now to FIG. 2, additional details will be provided regarding the operation of the form renderer 114. As discussed briefly above, the form renderer 114 is configured to generate renderer-specific markup 126A, such as HTML, that can be rendered by a rendering client 128, such as the Web browser 108, in order to present a form 130. In order to generate the markup 126A, the form renderer 114 utilizes a renderer agnostic declarative form definition 115A (the “form definition”).

The form definition 115A comprises declarative data that defines a layout for the form 130. More specifically, each form definition 115A contains declarative data that specifies the details of the user interface controls to be included in the form 130 as well as the layout of the controls. A form definition 115A may also contain declarative data for specifying style, data bindings, code resources, and property extensibility. The data within the form definition 115A is rendering technology agnostic. This means that the contents of the form definition 115A are not tied to any specific rendering technology or rendering client.

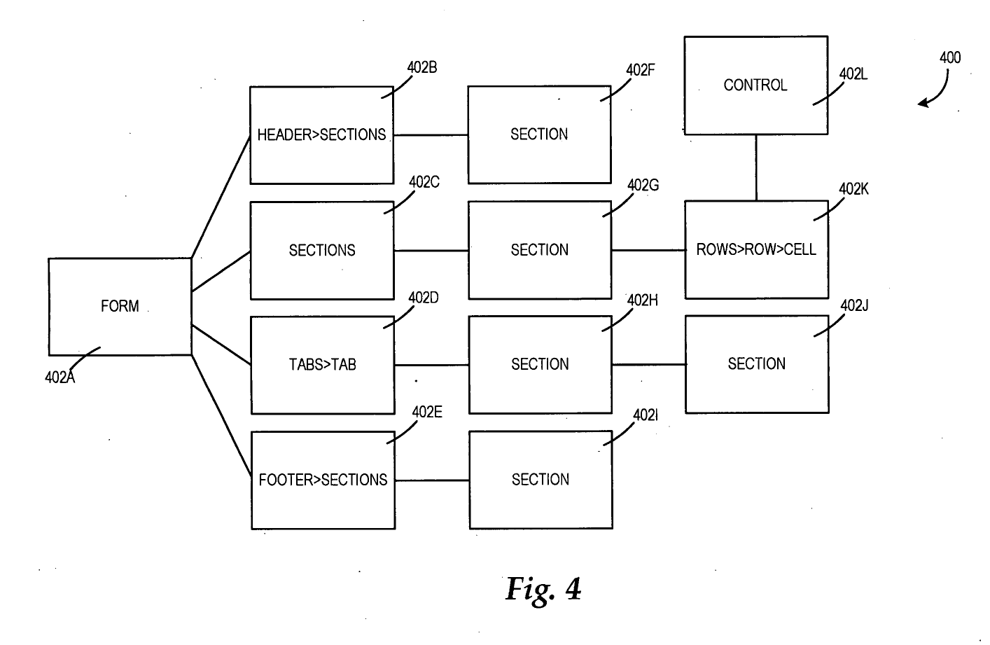

According to one implementation, the contents of the form definition 115A are specified using the Form Extensible Markup Language (“FormXML”) schema implemented by MICROSOFT CORPORATION in its MICROSOFT DYNAMICS business software. FormXML is a declarative data format used to specify the layout and control placement within forms. The bulk of the FormXML schema is for specifying layout-related elements. FormXML-based forms include form controls that are organized into sections of rows and cells. Sections can then be further organized into tabs as well as header and footer regions. In addition to layout, FormXML includes element style definitions, simple event handler registration, and generic property bags to store custom properties. FormXML is inherently rendering technology agnostic because it has no direct rendering solution. It should be appreciated that although the embodiments presented herein have been described as using FormXML to define forms in a renderer agnostic manner, any declarative form markup language could be utilized to specify the contents of the form definition 115A. Additional details regarding the FormXML schema are provided below with respect to FIG. 4.

According to embodiments, the form renderer 114 also utilizes a transformation definition file, such as the schema agnostic XSLT file 124A. The schema agnostic XSLT file 124A defines a transformation from the renderer agnostic format specified by the declarative form definition 115A to renderer-specific code. For instance, XSLT may be defined for transforming the declarative form definition to renderer-specific markup, such as HTML or XAML. In one implementation, the XSLT is schema agnostic, meaning that the same XSLT 124A can be utilized to render all forms specified by the declarative form definition regardless of the schema of the returned data set.

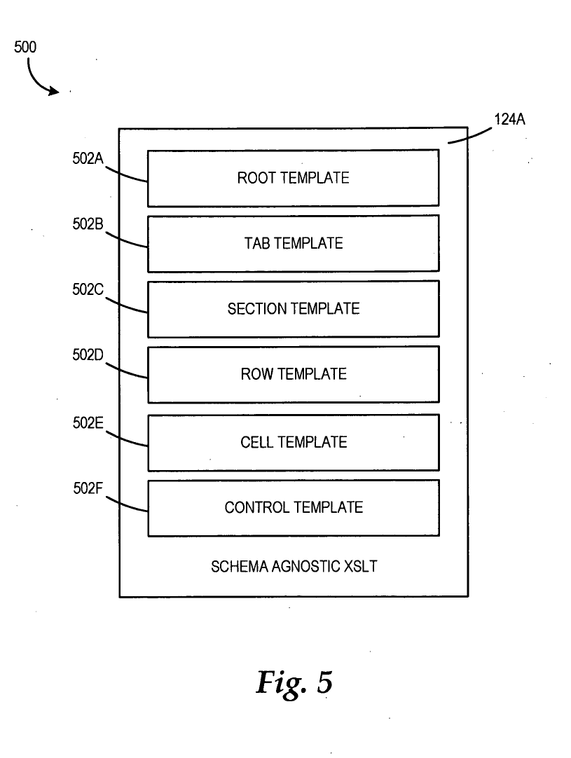

In one embodiment the XSLT file 124A specifies a transformation from FormXML to HTML. In another embodiment, the XSLT file 124A specifies a transformation from FormXML to HTML and ASP.NET code. In another embodiment, the XSLT file 124A specifies a transformation from FormXML to XAML. It should be appreciated that these types of transformations are merely illustrative and that an XSLT file 124A may be specified for performing a transformation between any renderer agnostic declarative form definition and any type of renderer-specific markup or program code. Additional details regarding a schema agnostic XSLT file 124A utilized in one implementation to transform FormXML to HTML will be provided below with reference to FIG. 5.

In order to perform the transformation specified by the XSLT file 124A, the form renderer 114 is also configured to execute an XSLT processor 122. The XSLT processor 122 takes the form definition 115A, the XSLT file 124A, and form data 118A retrieved from the database 120 as input. The form data 118A specifies the fields that should be present in the form 130 and specifies a data type for each of the fields. The XSLT processor 122 utilizes the XSLT file 124A to generate the renderer-specific markup 126A from the form definition 115A and the form data 118A. Once the renderer-specific markup 126A has been generated, it is passed to the rendering client 128 for rendering. The rendered form 130 is then displayed and input may be received into the form.

In one implementation, the form renderer 114 is implemented as a Web part. In this implementation, an ASP.NET data source control is utilized to retrieve the form data 118A from the database 120. It should be appreciated, however, that the form renderer 114 might be implemented using any suitable server-side or client-side run-time environment.

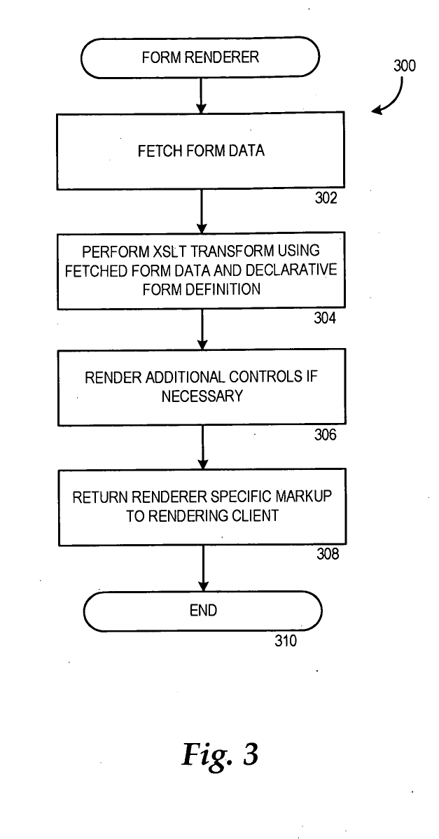

Referring now to FIG. 3, additional details will be provided regarding the embodiments presented herein for declaratively defining and rendering a form 130. In particular, FIG. 3 is a flow diagram illustrating aspects of the operation of the form renderer 114 in one embodiment presented herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where the form data 118A is retrieved from the database 120. As mentioned above, a suitable data control may be utilized to retrieve the form data 118A from the database 120. Once the form data 118A has been retrieved, the routine 300 proceeds to operation 304, where the XSLT processor 122 performs the transformation using the schema agnostic XSLT 124A, the form data 118A, and the renderer agnostic declarative form definition 115A as input. As discussed above, the output from the transformation operation is the renderer-specific markup 126A.

From operation 304, the routine 300 proceeds to operation 306, where any additional user interface controls are rendered. For instance, in an embodiment where a transformation is performed from FormXML to HTML and ASP.NET code, it may be necessary for the Web server program 110 to render any ASP.NET controls into HTML in a manner that is suitable for display by the Web browser 108. Once the renderer-specific markup 126A has been completely rendered, it is returned to the rendering client for rendering. This occurs at operation 308. The rendering client then renders the renderer-specific markup 126A to produce the form 130. From operation 308, the routine 300 proceeds to operation 310, where it ends.

Turning now to FIG. 4, details regarding the FormXML schema utilized herein in one implementation will be provided. In particular, FIG. 4 is a schema diagram that graphically illustrates the structure of the FormXML schema 400 utilized in one embodiment herein. As shown in FIG. 4, the root element in FormXML is a form element 402A. The form element 402A may have layout-defining child elements including the header element 402B, the sections element 402C, the tabs element 402D, and the footer element 402E. The bulk of FormXML typically consists of these layout-defining elements. In one embodiment, the FormXML schema 400 utilized herein also includes additional resource defining child elements of the form element 402A for specifying style, data binding, code resources, and property extensibility.

As shown in FIG. 4, a header element 402B has one or more section elements 402F as children. A section in FormXML can have a header, can be expandable, can have tabs, or none of the above. A sections element 402C may also have a section element 402G as a child element. A tab element 402D may have a sections element 402H as a child which, in turn, may have one or more section elements 402J. A footer element 402E may also have a section element 402I as a child element.

Each section element 402G includes a number of additional elements 402K that together define a grid structure. The grid defines the number of rows and columns each section contains and cells within the grid. For each cell, a control element 402L is specified that identifies a user interface control for that cell. In particular, the FormXML schema 400 includes a generic and relatively bare control element 402L that includes a property bag. By storing additional properties in the property bag, virtually any type of control can be represented.

Referring now to FIG. 5, additional details will be provided regarding a schema agnostic XSLT file 124A utilized in one implementation for transforming FormXML to HTML. In particular, FIG. 5 is a data structure diagram showing the contents of a schema agnostic XSLT file 124A provided in one embodiment for transforming the FormXML schema 400 described above to HTML.

As shown in FIG. 5, each of the major groups of FormXML elements has an associated XSL template. For instance, in one embodiment, the schema agnostic XSLT file 124A includes a root template 502A, a tab template 502B, a section template 502C, a row template 502D, a cell template 502E, and a control template 502E. The schema agnostic XSLT file 124A reads in the FormXML contained in the form definition 115A as a parameter and applies these templates to render the form 130. Additional details regarding the operation of each of the templates 502A-502E will be provided below.

The root template 502A matches on the data source root and renders the FormXML form element 402A. In particular, the root template 502A renders a single HTML <div> element and sets the height and width based on properties in the form element 402A. The root template 502A also applies the other templates identified above. Header sections are rendered first, then sections, then tabs, and finally footer sections.

The tab template 502B is responsible for outputting tabs in a form and creating an HTML <div> element for each tab. The tab template 502B also applies the section template 502C in the HTML <div> element. The section template 502C renders HTML <table> elements for each section. The tab template 502B applies the section template 502C in the HTML <table> element.

The row template 502B renders an HTML <tr> element for each row in the table. The row template 502B also renders the cell template 502E in the HTML <tr> element. In turn, the cell template 502E renders an HTML <td> element for each cell element in a row. The row template 502D applies the cell template 502E in the HTML <tr> element.

The control template 502E is responsible for rendering the HTML for the user interface controls within the form 130. In order to render the most appropriate control, the control template 502E may examine the form data 118A to identify the attributes necessary to render the control. It should be appreciated that, according to embodiments, the XSLT file 124A may be configured to adapt to settings in the form definition 115A, such as elements that specify a style for the form 130.

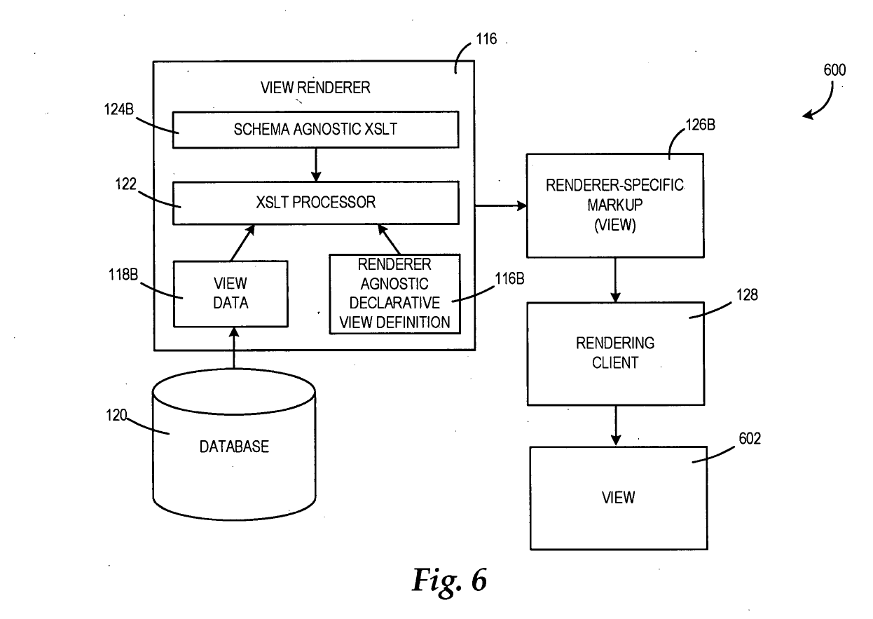

Turning now to FIG. 6, additional details will be provided regarding the operation of the view renderer 116. As discussed briefly above, the view renderer 116 is configured to generate renderer-specific markup 126B, such as HTML, that can be rendered by a rendering client 128, such as the Web browser 108, in order to present a view 602. In order to generate the markup 126B, the view renderer 116 utilizes a renderer agnostic declarative view definition 115B (the “view definition”).

The view definition 115B comprises declarative data that defines a layout for the view 602. Like the form definition 115A described above, the data within the view definition 115B is rendering technology agnostic. This means that the contents of the view definition 115B are not tied to any specific rendering technology or rendering client.

According to one implementation, the contents of the view definition 115B are specified using the View Extensible Markup Language (“ViewXML”) schema implemented by MICROSOFT CORPORATION. ViewXML is a declarative data format used to specify the layout of views. Like FormXML, ViewXML is inherently rendering technology agnostic because it has no direct rendering solution. It should be appreciated that although the embodiments presented herein have been described as using ViewXML, any render agnostic declarative form markup language could be utilized to specify the contents of the view definition 115B.

According to embodiments, the view renderer 116 also utilizes a transformation definition file, such as the schema agnostic XSLT file 124B. The schema agnostic XSLT file 124B utilized by the view renderer 116 defines a transformation from the renderer agnostic format specified by the declarative view definition 115B to renderer-specific markup or program code. For instance, XSLT may be defined for transforming the ViewXML declarative form definition 115B to renderer-specific markup, such as HTML, HTML and ASP.NET, or XAML. As with the XSLT 124A utilized by the view renderer 114, the XSLT 124B is schema agnostic, meaning that the same XSLT can be utilized to render all views specified by the declarative view definition regardless of the schema of the returned data set.

In order to perform the transformation specified by the XSLT file 124B, the view renderer 116 is also configured to execute the XSLT processor 122. The XSLT processor 122 takes the view definition 115B, the XSLT file 124B, and view data 118B retrieved from the database 120 as input. The view data 118B specifies the data that should be shown in the view 602. The XSLT processor 122 utilizes the XSLT file 124B to generate the renderer-specific markup 126B from the view definition 115B and the view data 118B. Once the renderer-specific markup 126B for the view 602 has been generated, it is passed to the rendering client 128 for rendering. The rendering client 128 then displays the rendered view 602.

In one implementation, the view renderer 116 is implemented as a Web part. In this implementation, an ASP.NET data source control is utilized to retrieve the view data 118B from the database 120. It should be appreciated, however, that the view renderer 116 might be implemented using any suitable server-side or client-side execution environment.

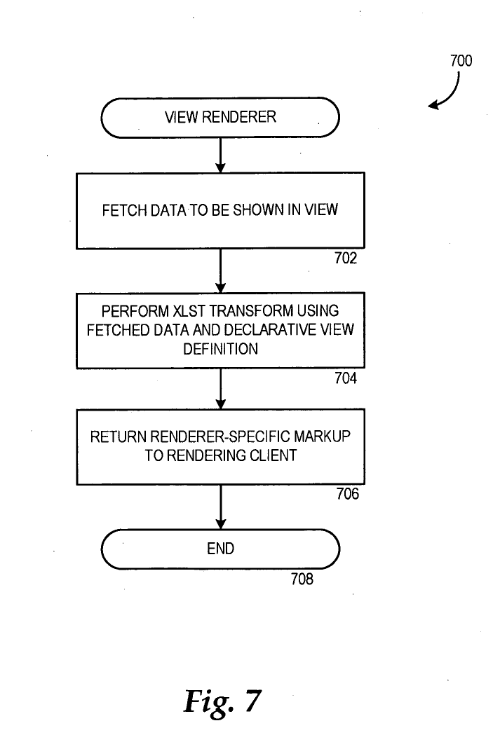

Referring now to FIG. 7, additional details will be provided regarding the embodiments presented herein for declaratively defining and rendering a view. In particular, FIG. 7 is a flow diagram illustrating aspects of the operation of the view renderer 116 in one embodiment presented herein. The routine 700 begins at operation 702, where the view data 118B is retrieved from the database 120. As mentioned above, a suitable data control may be utilized to retrieve the view data 118B from the database 120.

Once the view data 118B has been retrieved, the routine 700 proceeds to operation 704, where the XSLT processor 122 performs the transformation using the schema agnostic XSLT 124B, the view data 118B, and the renderer agnostic declarative view definition 115B as input. As discussed above, the output from the transformation operation is the renderer-specific markup 126B.

From operation 704, the routine 700 proceeds to operation 706, where the renderer-specific markup 126B is returned to the rendering client 128 for display. The rendering client 128 then renders the renderer-specific markup 126B to produce the view 602. From operation 706, the routine 700 proceeds to operation 708, where it ends.

According to one embodiment presented herein, the ViewXML schema utilized herein to specify a view of a data set is extended to include conditional formatting elements. Through the use of these elements, formatting can be specified that is conditional upon values specified in the data set. In this manner, formatting can be applied to the data set at run time depending upon values set forth in the data. TABLE 1 shows sample markup including the conditional formatting elements provided in this embodiment. It should be appreciated that the elements shown in TABLE 1 are merely illustrative and that other elements and syntax may be utilized.

TABLE 1

```
<View>
  <Query>
    <Where>
      <Gt>
        <FieldRef Name=“Expires”/>
        <Value Type=“DateTime”>
          <Today/>
        </Value>
      </Gt>
    </Where>
  </Query>
  <ViewFields>
    <FieldRef Name=“ LinkTitle”/>
    <FieldRef Name=“Price”/>
    <FieldRef Name=“Column A”/>
  </ViewFields>
  <CondFormats>
    <!-- 2 Icon Set -->
    <CondFormat Type=“Icon”>
      <Icons FieldName=“Column A” ID=“Icon-Set
ID”>
        <Icon Path=“<Page Relative URL>/red-
arrow.gif” Name=“$Resources:Core,RedArrow” >
          <Where>
            <Gt>
              <FieldRef Name=“Expires”/>
              <Value Type=‘Counter’>75</Value>
            </Gt>
          </Where>
        </Icon>
        <Icon Path=“<Page Relative URL>/red-
arrow.gif” Name=“$Resources:Core,RedArrow” >
          <Where>
            <Lte>
              <FieldRef Name=“Expires”/>
              <Value Type=‘Counter’>75</Value>
            </Lte>
          </Where>
        </Icon>
      </Icons>
    </CondFormat>
  </CondFormats>
```

In the example shown in FIG. 1, conditional formatting elements have been defined for displaying different icon sets dependent upon the value of a field. In particular, a <CondFormats> element is defined that is the root node for all conditional formatting styles. A <CondFormat> element is also defined that is the node for each conditional formatting style. An <Icons> element is defined that is the parent node that defines the icon set. The “FieldName” parameter defines the column for the icon sets. The “ID” parameter is a unique identifier corresponding to the icon set to be used.

The <Icon> element represents a node corresponding to a single icon. The “Path” parameter identifies the uniform resource locator (“URL”) of the icon. The “Name” parameter identifies the name of the icon image. Inside each <Icon> element there is a <Where> element that defines the condition to display the specified icon. Within the <Where> element, a field and value may be utilized to specify the condition. In this manner, conditional formatting can be specified at run-time, rather than at the time the form is defined.

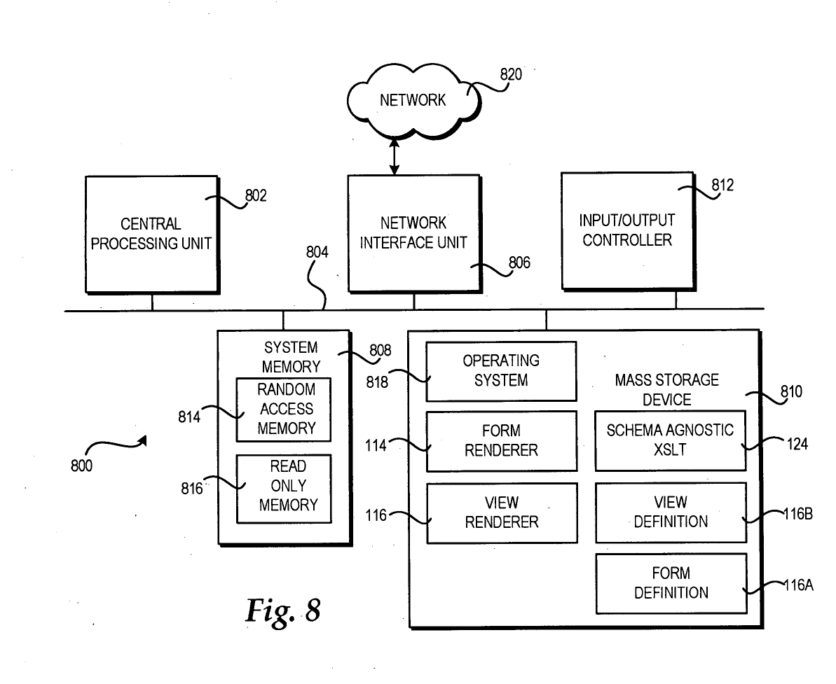

FIG. 8 shows an illustrative computer architecture for a computer 800 capable of executing the software components described herein for rendering declaratively defined forms and views in the manner presented above. The simplified computer architecture shown in FIG. 8 illustrates a conventional desktop, laptop, or server computer and may be utilized to execute any aspects of the software components presented herein and described as executing on the client computer 102 or the server computer 104.

The computer architecture shown in FIG. 8 includes a central processing unit 802 (“CPU”), a system memory 808, including a random access memory 814 (“RAM”) and a read-only memory (“ROM”) 816, and a system bus 804 that couples the memory to the CPU 802. A basic input/output system containing the basic routines that help to transfer information between elements within the computer 800, such as during startup, is stored in the ROM 816. The computer 800 further includes a mass storage device 810 for storing an operating system 818, application programs, and other program modules, which are described in greater detail herein.

The mass storage device 810 is connected to the CPU 802 through a mass storage controller (not shown) connected to the bus 804. The mass storage device 810 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available computer storage media that can be accessed by the computer 800.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800.

According to various embodiments, the computer 800 may operate in a networked environment using logical connections to remote computers through a network such as the network 820. The computer 800 may connect to the network 820 through a network interface unit 806 connected to the bus 804. It should be appreciated that the network interface unit 806 may also be utilized to connect to other types of networks and remote computer systems. The computer 800 may also include an input/output controller 812 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 810 and RAM 814 of the computer 800, including an operating system 818 suitable for controlling the operation of a networked desktop, laptop, or server computer. The mass storage device 810 and RAM 814 may also store one or more program modules and data files. In particular, the mass storage device 810 and the RAM 814 may store the form renderer 114, the view renderer 116, the schema agnostic XSLT 124, the view definition 115B, and the form definition 115A, each of which was described in detail above with respect to FIGS. 1-7. The mass storage device 810 and the RAM 814 may also store other types of program modules and data files.

Based on the foregoing, it should be appreciated that technologies for rendering declaratively defined forms and views are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for rendering a form, the method comprising:
storing a declarative form definition;
storing an Extensible Stylesheet Language Transformation (“XSLT”) file, the XSLT file defining a transformation from the declarative form definition to renderer-specific code;
retrieving form data; and
performing an XSLT transformation using the XSLT file, the declarative form definition, and the form data to generate renderer-specific markup that will generate the form when rendered by a rendering client.

2. The method of claim 1, wherein the declarative form definition comprises declarative data that defines a layout for the form.

3. The method of claim 2, wherein the declarative form definition is rendering technology agnostic.

4. The method of claim 3, wherein the declarative form definition comprises Form Extensible Markup Language (“FormXML”).

5. The method of claim 1, wherein the XSLT file is schema agnostic.

6. The method of claim 5, wherein the renderer-specific markup comprises HyperText Markup Language (“HTML”).

7. The method of claim 5, wherein the renderer-specific markup comprises Extensible Application Markup Language (“XAML”).

8. A method for rendering a view, the method comprising:
storing a declarative view definition;
storing an Extensible Stylesheet Language Transformation (“XSLT”) file, the XSLT file defining a transformation from the declarative view definition to renderer-specific code;
retrieving view data; and
performing an XSLT transformation using the XSLT file, the declarative view definition, and the view data to generate renderer-specific markup that will generate the view when rendered by a rendering client.

9. The method of claim 8, wherein the declarative view definition comprises declarative data that defines a layout for the view.

10. The method of claim 9, wherein the declarative view definition is rendering technology agnostic.

11. The method of claim 10, wherein the declarative view definition comprises View Extensible Markup Language (“ViewXML”).

12. The method of claim 8, wherein the XSLT file is schema agnostic.

13. The method of claim 12, wherein the renderer-specific markup comprises HyperText Markup Language (“HTML”).

14. The method of claim 12, wherein the renderer-specific markup comprises Extensible Application Markup Language (“XAML”).

15. A computer-readable medium having computer-executable instructions stored thereon which, when executed by a computer, cause the computer to:
store a declarative form definition;
store an Extensible Stylesheet Language Transformation (“XSLT”) file, the XSLT file defining a transformation from the declarative form definition to renderer-specific code;
retrieve form data; and to
perform an XSLT transformation using the XSLT file, the declarative form definition, and the form data to generate renderer-specific markup that will generate a form when rendered by a rendering client.

16. The computer-readable medium of claim 15, comprising further computer-executable instructions which, when executed by the computer will cause the computer to:
store a declarative view definition;
store a second Extensible Stylesheet Language Transformation (“XSLT”) file, the second XSLT file defining a transformation from the declarative view definition to renderer-specific code;
retrieve view data; and to
perform an XSLT transformation using the second XSLT file, the declarative view definition, and the view data to generate renderer-specific markup that will generate a view when rendered by the rendering client.

17. The computer-readable medium of claim 16, wherein the declarative form definition comprises declarative data that defines a layout for the form and the declarative view definition comprises declarative data that defines a layout for the view.

18. The computer-readable medium of claim 17, wherein the declarative form definition and the declarative view definition are rendering technology agnostic.

19. The computer-readable medium of claim 18, wherein the declarative form definition comprises Form Extensible Markup Language (“FormXML”) and wherein the declarative view definition comprises View Extensible Markup Language (“ViewXML”).

20. The computer-readable medium of claim 19, wherein the renderer-specific markup comprises HyperText Markup Language (“HTML”).
